(19) United States
(12) Patent Application Publication
(10) Pub. No.: US 2009/0125295 A1
(43) Pub. Date: May 14, 2009

(54) Voice auto-translation of multi-lingual telephone calls

(76) Inventor: William Drewes, Houston, TX (US)

Correspondence Address: WILLIAM DREWES, 14781 MEMORIAL DRIVE, HOUSTON, TX, 77079, US

(21) Appl. No.: 12/290,761

(22) Filed: Nov. 3, 2008

Related U.S. Application Data
(60) Provisional application No. 60/986,601, filed on Nov. 9, 2007.

(51) Int. Cl. G06F 17/28; H04M 3/42

(52) U.S. Cl. 704/3; 379/202.01

(57) ABSTRACT

The present invention discloses the system design, module requirements, specifications and methods that comprise the core technology required to enable the development of a viable Multi-Lingual Auto-Translation Telephony System. During a conversation utilizing said Multi-Lingual Auto-Translation Telephony System, each participant speaks only one language for the duration of the conversation, and there is no limit on the number of participants that may participate in said conversation, provided said number of participants is two or greater, nor is there any limit on the number of different languages that may be employed by said different participants during said conversation.

This application claims priority from provisional application Ser. No. 60/986,601, filed on Nov. 9, 2007.

### BACKGROUND OF THE INVENTION

1. Field of the Invention

The system employs the following technologies: Telephony, Internet, Statistical Speaker Independent and Background Noise tolerant Voice Recognition (SVR), Statistical Machine Translation (SMT), and Language and Country Location Specific Voice Synthesis (VS).

2. Description of Prior Art

With advances in Speech Recognition, Statistical Machine Translation, and Voice Synthesis, automated Multi-Lingual Voice-to-Voice translation has become a reality. The accuracy of Statistical Machine Translation is greatly enhanced when all of the material to be translated relates to a specific pre-defined subject area or topic (e.g., Military, Finance, Business, etc.), known as a “Domain”. The basic idea is that while words and phrases may have several different meanings, when using a Domain, a situation where “everybody” is talking about precisely the same subject, the probability that the intended meaning of the specific words and phrases used, as they relate to the specific topic or domain, naturally become significantly more specific and narrowly defined. Thus the resulting translation will more precisely reflect what the speaker actually intends to convey and translation accuracy is significantly increased. An example of Voice-to-Voice translation utilizing Statistical Machine Translation and a Subject Specific Domain is IBM's MASTOR PC based Voice-to-Voice translation system with a Subject Specific Domain relating to “The War in Iraq”. The MASTOR PC system is currently being used on laptop PCs by U.S. Armed Forces deployed in Iraq in 2006. It is being used to interactively communicate with Arabic speaking Iraqis. The MASTOR PC system is reported to achieve highly accurate interactive translation results.

Given the above mentioned advances in Multi-Lingual Voice-to-Voice translation, it would therefore be most advantageous for a system and methods to be developed that would extend this capability to the existing infrastructure in the world of telephony, including, wire-line, mobile, Internet based VOIP, or any combination thereof.

### SUMMARY OF THE INVENTION

The present invention utilizes Voice-to-Voice translation technology, detailed in the Description of Prior Art Section (above) together with a Network Telephony Server Conference Call Bridge or an Internet VOIP Conference Bridge to enable Voice-to-Voice Multi-Lingual Auto-Translated telephone calls. Designing a viable Multi-Lingual Telephony system entails the solution of problems that are both practical as well as technical.

First, there is the question of how can people both talk and concurrently hear translations of what other people said, while connected to a Telephony Network Server or a VOIP software Conference Bridge. In a Multi-Lingual Auto-Translated telephone conversation in which the participants are speaking a maximum of two languages, there should be no inherent problem with multiple speakers and multiple voice translations to be heard by all conversation participants on a conference bridge, as long as all participants talk “In-Turn”.

For example, a speaker would first talk in his own language, and all other participants on the Conference Bridge would hear the speaker as he or she talks. This speaker would then signal to the system that a translation of his/her words should be initiated. The speakers dialogue would then be translated into the second language and then vocalized via voice synthesis in the second language, so that all telephone call participants on the bridge would then hear the voice synthesized translation of the speakers' words in the second language, regardless of whether each participant understands the second language or not.

A flaw in this approach becomes apparent when using a conference bridge for conversations in which three or more languages are spoken by the conversation participants. The problem is not one of talking “in turn” nor is the problem that the talker is speaking original dialogue on the conference bridge and the other participants hear the original speech of a talker while he/she is speaking in a language that other conversation participants may not understand. In fact, hearing a conversation participant talk in their own language is actually positive in that all conversation participates regardless if they understand the speaker's language or not, will be able to distinguish the mood and tone of the speaker's voice.

Rather, in a conversation in which three or more languages spoken, for all conversation participants to hear voice multiple synthesized translations of each speaker “while he/she is on the bridge” would make each conversation participant's experience far too lengthy, burdensome, and untenable (i.e., for each conversation participant would have to listen to at least two voice synthesized translations in languages that they probably do not understand).

Utilizing the method detailed hereunder, when a speaker signals to the system that a translation of his/her words should be initiated, each conversation participant would then be taken “off the conference bridge”, and while “off the conference bridge” each said respective conversation participation would then hear the respective voice synthesized translation of the previous speakers words, in each participant's own respective language. After each conversation participant hears a voice synthesized translation of the previous speakers words, while “off the conference bridge”, each conversation participant is then brought back “on the conference bridge”, and the conversation continues. In this manner, each conversation participant hears only one voice synthesized translation, each in his/her own respective language, and the process is far more concise and user-friendly.

Next, there is the practical issue of “who talks when”, which in a multi-lingual telephone conversation is an important issue which must be resolved in an easily comprehensible and user friendly manner.

The present invention utilizes DSP (Digital Signal Processing) to monitor each conference call participant's use of the telephone keypad (or alternatively the use of standard voice commands) to effect a coherent and well orchestrated conversation.

The initiator of the telephone call (i.e., the subscriber who pays for the call) will usually make his opening remarks or welcoming statement. In order to signal that he/she has finished talking and wants the dialogue to be translated to each respective conversation participant, the speaker will hit (press) a particular key on the telephone key pad (i.e., the pound “#” key). Once the pound key is hit, the system will take all respective telephone call participants “Off the Bridge” in order to hear the voice synthesized translation of what the previous speaker said in his/her own respective native language. After each call participant finishes hearing the verbalized translation of what the previous speaker said, the system will then automatically bring all telephone call participants back “On the Bridge”.

It should be noted that the telephone number of each participant, as well each participants native language (or language of choice) as well as their gender (in order to determine the gender to be used for Voice Synthesis vocalized translation to be heard by other participants while they are “Off the Bridge), are all easily specified by the subscriber in the subscriber's “Address Book”, located in a subscriber's own “Internet Subscriber's Interface Module” described in below “Detailed Description of the Invention” section).

There are several possible scenarios regarding the issue of “Who Talks Next”. Said scenarios are described in below in the “Detailed Description of the Invention” section. The scenario is chosen by the subscriber who will indicate said chosen scenario option in their own “Internet Subscriber's Interface Module”. In one such scenario, when participants are “On the Bridge” they can hit a particular key on the telephone key pad (i.e., the star “*” key), in order to inform the subscriber (who pays for the call that they would like a turn to talk). The subscriber then chooses who will talk next by hitting a particular key on the telephone key pad, and then saying the name of the participant that the subscriber wants to talk next. At this point, all participants are then brought “Off the Bridge”, and informed in their own respective language the name of the participant who will talk next, after said notification, all participants are brought back “On the Bridge”, and control for talking will be automatically initiated for the chosen participant.

Utilizing the method disclosed in USPTO Patent Application 20080177528 (Serial No. 008082, Series Code: 12), Filed: Jan. 8, 2008 “Method of enabling any-directional translation of selected languages”, the system will be enabled with the capability to effect conversations with participants who use >2 (any number of different) languages thereby enabling each telephone call participant to both talk with any and all other participants in their own native language, as well as to hear vocalized translated responses of any and all of the other conversation participants in their own language.

The above, as well as other functionality, required to manage and orchestrate a Multi-Lingual Auto-Translated telephone conversation is performed by the “Command & Control Module”, which is described in detail below in the “Detailed Description of the Invention” section.

It should be noted that procedure for a participant to enter an “Auto-Translated Multi-Lingual” conference call is similar to that of entering a regular conference call, with just a few differences. The participant will dial a specified conference bridge telephone number, and will be asked for a conference code, which conference code was automatically e-mailed to the participant when the subscriber, using their own “Internet Subscriber's Interface Module” scheduled the call.

Unlike regular single language conference calls, the participant entering the conference bridge will also be requested to say his/her name, which will be recorded for the purpose of announcing his/her arrival to the other conference call participants. Also, each participant entering the conference call will then have to wait for an “Interrupt” before they will be automatically brought “On the Bridge”, and his/her arrival announced to all other participants. An “Interrupt” is a point in time when “no one is talking”. That is; a point in time after which participants are brought back “On the Bridge”, after hearing translations of the previous speaker in their own respective languages.

The accuracy of a statistical translation engine corresponds to the amount of “Original Language Text” which is translated by professional human translators into one or more respective other languages, on a sentence by sentence basis. These Original Language documents and respective professional human translations thereof are input to a “Statistical Language Construction Engine”, which through the implementation of probability theory will then construct “Statistical Language Pairs”. The same process is used to construct “Context Specific Domains”.

As such, the system disclosed herein, is designed to continually improve the accuracy and relevance of the systems translation capability by employing a very simple methodology that is inherent in the system. As part of the legal contract to which every potential subscriber must agree to (i.e., click “I Agree”) during the registration process for new subscribers, the contract, available to the user, will specify that the company providing the system may anonymously copy “Original Speaker Text” (not translations) from the conversations initiated by the subscriber. This statistically valid percentage of this “Original Speaker Text” is submitted, on a sentence-by-sentence basis, to professional human translators for translation into other respective languages. These Original Language sentences and the corresponding respective “other-language” professional human translations thereof are input to a “Statistical Language Construction Engine”, which through the implementation of probability theory will thereby continually update and improve the accuracy and relevance “Statistical Language Pairs”, as well as that of the respective “Context Specific Domains”.

As an additional service to the subscriber, all Original Speaker Text, of each “Auto-Translate Telephone Call” conversation participant, as well as the respective textual translations thereof are generated and stored by the Command and Control module (see: below) as conversation transcripts. Said transcripts of each conversation made by the subscriber are thus automatically stored for subsequent viewing by the subscriber. The subscriber can subsequently view said conversation transcripts via the subscriber's own “Internet Subscriber's Interface Module”.

For each “Auto-Translate Telephone Call” conversation, statistics will be automatically calculated based on said conversation transcripts detailing the “Translation Work Performed” for each of the subscriber's conversations. Said statistics will be made available to the subscriber for viewing through said subscriber's own “Internet Subscriber's Interface Module”.

Said statistics of “Translation Work Performed” for each of the subscribers conversations, will also be used to generate CDR a (Call Data Record) for the purpose of customer billing for “Translation Work Performed” for each subscriber-initiated conversation, in addition to connect time and number of participants.

Finally, the system will have the capability to be configured using a variety of “Calling Modes”. Calling Modes dramatically increases the flexibility of how the system can be used, specifically when, how and where the benefits of the system can be derived. The different Calling Modes and the respective uses each of said Calling Modes are described in the hereunder “Detailed Description of the Invention” section.

### BRIEF DESCRIPTION OF THE DRAWINGS

FIG. 1 is a schematic diagram of the architecture and flow of the Internet Subscriber Interface Module.

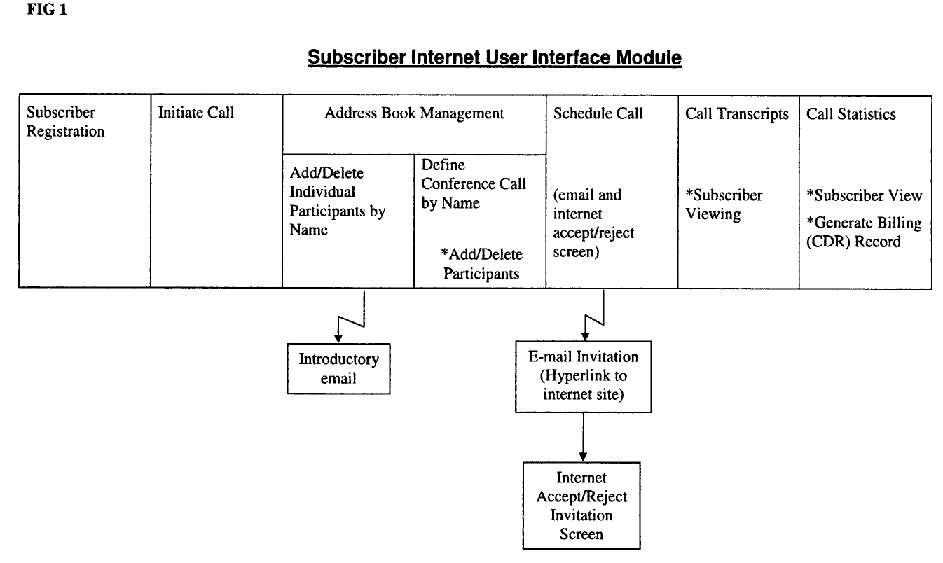

FIG. 2 is a schematic diagram of the architecture and flow of the Command and Control Module.

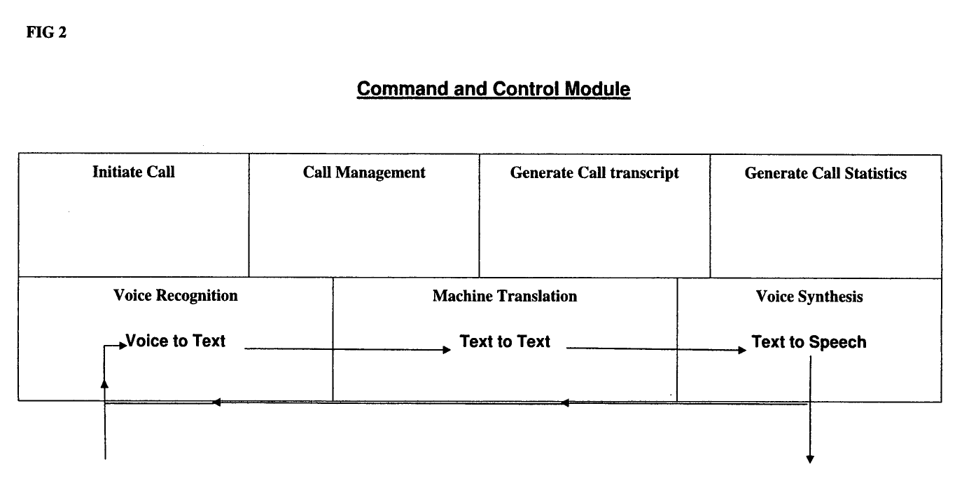

### DETAILED DESCRIPTION OF THE INVENTION

The Software programs required for the system will be comprised of two basic modules, first, an “Internet Subscriber Interface module”, and second, a “Command & Control module”, both of which are described hereunder.

1. Internet Subscriber Interface Module

The Voice “Auto-Translation” of Multi-Lingual Telephone call system” Internet User Interface Module is a multi-functional module that is central to the system. The module will be part of the subscriber account specific functionality within a communications provider's Web Site. A Mobile Device Internet version will be developed so that subscribers on the go will have access to the module through their Internet enabled mobile phones or other mobile Internet enabled devices.

The module will:
a) Be part of a Communication Provider's subscriber registration process for the “Auto-Translate Telephone Call” service.
b) Require the subscriber to define the subscriber's telephone number(s) for which the service will be enabled, the subscribers name or nick name (that will be used by the system), the subscriber's communication language of choice, e-mail address, as well as the subscriber's gender. The gender indication (which will be optional) will dictate to the voice synthesis module whether to use a male or female voice when vocalizing the translation(s) of the subscriber's speech to each respective “Auto-Translate Telephone Call” participant(s) in said participant's respective language of choice.
c) Enable the subscriber to pre-define both individual (one to one) as well as group conference “Auto-Translate Telephone calls” with participant information that will be stored in an “Address Book”, similar to Address Book facility widely used in e-mail programs. The required Address Book information for each of the subscriber specified participants will be name and/or nick name, telephone number, country code (or geographic location), communication language of choice, e-mail address and gender (optional). Conference calls can then be defined by giving each conference call a unique name, and specifying specific participants in the particular conference call by selecting individual participants from the Address Book. Defined conference calls can also be saved in the Address Book using their unique name.
d) E-mails will be automatically sent to newly defined participants, written in each newly defined participant's language of choice, identifying the subscriber who defined the specific individual in their “Auto-Translate Telephone Call” address book, and explaining the conference “Auto-Translate Telephone call” service.
e) The user will schedule and initiate a call through the Internet User Interface Module. The subscriber can choose an individual participant from the system Address Book or a predefined Conference Call by selecting either the Name (or the nick name) of the call as predefined in the Address Book. In the case of a predefined Conference Call, the user will have the opportunity to add and/or delete participants from the list of predefined participants displayed. Alternately, the subscriber can create a Conference Call on the fly by selecting a list of participants from the Internet User Interface Module Address Book.

At any time, the user can select the “Initiate Call” option, and the “Auto-Translate Telephone call Telephony Conference Bridge Server will initiate the call by automatically telephoning both the Subscriber and the Participant(s). Pre-Scheduled calls can be automatically scheduled in the same manner at the specified date and time.

For prescheduled calls, the Internet User Interface Module will automatically send e-mail RSVP invitations to all specified participants, and acceptance responses will be automatically indicated and viewed in the Internet User Interface Module call definition next to the name or nick name of each participant.

The Internet Subscriber Interface Module is accessed through the Internet, and therefore can be accessed by the subscriber through the use of any stationary or mobile Internet enabled device, including, but not limited to, a PC computer, Laptop computer or Internet enabled Mobile Phone.

The subscriber will also be able to initiate an “Auto-Translate Telephone call” from “any telephone”, including landline, mobile, as well as a VOIP service to dial a specified telephone bridge number (toll-free recommended).

The user will specify a PIN number using the telephone keypad and then subsequently simply verbally say the name or nick-name of the “Auto-Translate Telephone call”, individual(s) or Conference Call name, as predefined in the subscribers Address Book.

The subscriber will then be able to issue voice commands to “Add” and/or “Delete” participants. To initiate the “Auto-Translate Telephone call”, the subscriber will then issue a Voice Command, such as “Initiate Call”.

Alternatively, specified telephone keypad buttons can be pressed and detected by DSP (Digital Signal Processing) to indicate required commands in any situation in which the use of voice recognition (as described above) is not preferable.

1.1. Transcript Storage and Access

Text transcripts of each “Auto-Translate Telephone Call” conversation made by a subscriber will be automatically generated in electronic text format by the “Command and Control Module” (see below).

The transcripts of every call made by a subscriber are then stored in the subscriber's call history database that is connected to and accessible from the Communication Provider's Internet subscriber account web portal (i.e., Internet User Interface Module). As a result, transcripts of all “Auto-Translate Telephone Calls” that the subscriber has made are made available for viewing through their own Internet subscriber account web portal.

The text that is generated by the voice recognition for the original language speech of each participant (i.e., prior to translation), as well as the text of the translations of said original language speech prepared for each respective “auto-translate conversation” participant in their respective different languages, will be saved in the subscriber's call history database. As a result, the subscriber can view a complete record of each call, including original speech, and respective translations.

There will be two types of viewing options that the subscriber can select. These viewing options are either “Vertical” or “Horizontal” “Vertical Viewing” is a view of the conversation transcripts in the subscribers own language of choice, which will consist of all original speaker dialogue spoken in the subscribers language of choice, as well as respective translations of “other language” original speakers dialogue (spoken by a conversation participant in a language other than the subscribers “language of choice”), displayed in the precise order in which the respective participants spoke during the Auto-Translate Conversation.

“Horizontal Viewing” of conversation transcripts will consist of each participant's respective dialogue in their own native language, as well as the respective translations of said speaker's dialogue as translated into the respective languages of all other conversation participants”), displayed in the precise order in which the respective participants spoke during the Auto-Translate Conversation.

1.2. Call Statistics and CDR (Call Data Record)

For each “Auto-Translate Telephone Call” conversation, statistics will be automatically calculated from said conversation transcripts detailing the “Translation Work Performed” for each of the subscriber's conversations. Said statistics will be made available to the subscriber for viewing through said subscriber's own “Internet Subscriber's Interface Module”.

Said statistics of “Translation Work Performed” for each of the subscribers conversations, will also be used to generate CDR a (Call Data Record) for the purpose of customer billing for “Translation Work Performed” for each subscriber-initiated conversation, in addition to connect time and number of participants.

It is anticipated that potential customers throughout the world will want to become “Auto-Translate Telephone Call” subscribers. In regions of the United States where incumbent Communication Providers do not provide the Auto-Translate Telephone Call service, and in foreign countries where other carriers provide voice wireline and mobile service, and such foreign carriers do not provide the Auto-Translate Telephone Call service, a method will be provided to enable said people and companies to subscribe to and use the Auto-Translate Telephone Call service without the active cooperation of the local incumbent Communication provider, as follows:

Regardless of where potential subscribers are in the world or which Communications Carriers are the incumbent providers, said potential subscribers can register for the service directly through the Web Site of the technology vendor. In this manner, the “technology vendor” that develops and provides the service to Communication Providers to sell to subscribers in their respective regions, can also sell directly to subscribers in regions where the service is not provided by a local incumbent Communication provider.

In such cases, the potential customer can register for the service directly through the Web Site of said technology vender. The Internet User Interface Module will have the capability to accept major credit cards as well as process prepaid business. This type of customer will call a specified telephone number (local toll free number is recommended) using the local carrier's network, and the call will be connected to the technology vendor's own Auto-Translate Telephony Server which will provide “Auto-Translate Telephone call” service for this type of “direct subscriber”. Billing for the service can be based on connect time, locations of the call participants, number of participants, as well as statistics relating to “Translation Work Performed” for each Auto-Translate telephone call. Said information will be used to automatically create a Call Data Record (CDR) relating to each call for the purpose of subscriber billing.

2. Command & Control Module

The Command & Control Module receives from the Internet Subscriber Interface Module all the information required to initiate a subscriber specified individual or conference “Auto-Translate Telephone Call” call. Alternately, a copy of the above mentioned information can be located on the Network Telephony Server. The above mentioned information, which is received from the Internet Subscriber Interface Module for each participant in the “Auto-Translate Telephone Call” includes:
1. Participant's Phone number (including Country Code & City Code)
2. Participant's Name OR Participant's “Nick Name”
3. Participant's Communication Language of Choice
4. Participant's email Address
5. Participant's Gender (Optional—To be used for Voice Synthesis)

Utilizing a Telephony Network Server conference bridge or Internet VOIP conference bridge software, or other conference bridging technique known to those skilled in the art, and the following software:
1. Voice Recognition Software (Voice-To-Text)
2. Machine Translation Software (Text-To-Text)
3. TTS Voice Synthesis Software (Text-To-Speech)

The Module will:
1) Telephone each participant and inform the participant in his/her respective language that he/she is receiving an “Auto-Translate Telephone Call”. In the case that one or more of the participant(s) does not answer, or chooses not to accept the telephone call, the initiating subscriber will then be informed of that by the system, and be given the choice whether to continue with the call or not. The initiating subscriber will then inform the system, through voice command or DPS telephone keypad signal, to either proceed or discontinue the “Auto-Translate Telephone Call”. In the case that the initiating subscriber chooses to discontinue the call, all other participants will be informed by the system, in their respective languages, which participant(s) are not available, and that the initiating subscriber has decided not to continue with the “Auto-Translate Telephone Call”.
Alternately, each party can call a specified Conference Bridge telephone number, and identify themselves via keying in a Conference Code, which was supplied to the participant either by the subscriber, or automatically e-mailed (RSVP) to the participant when the call was scheduled by the subscriber.
Transcript information detailing the above will be recorded in the initiating subscribers “Auto-Translate Telephone Call” Transcript database, and will be available for viewing in the initiating subscriber's Internet Subscriber Interface Module transcript viewing section.
2) In the case that all participants are present, or the initiating subscriber has chosen not to terminate the call, then the “Auto-Translate Telephone Call” will continue as follows: The subscriber who initiated the “Auto-Translate Telephone Call” will be given the first turn to speak. When the initiating subscriber finishes speaking, he/she will then either pause for a few seconds (e.g., five seconds) or he/she will press a specified keypad key, such as the pound or star key, in order to indicate to the system that the translation process should begin. All participants are then taken “Off the Conference Bridge” and informed by the system, in each respective participant's language of choice, that “the participant “John's” speech is now being translated. By the time this notification has finished, the translation process should be complete, and said translation is then heard by each participant (utilizing Voice Synthesis), in each participant's respective language of choice.
The translation process steps are as follows:
   a) Voice Recognition automatically transforms the talking participant's speech into text.
   b) This text is then automatically translated by Machine Translation into the languages of each “Auto-Translate Telephone Call” participant's respective Language of Choice.
   c) All participants are taken “Off the Conference Bridge” and each participant is informed in his/her respective language of choice that the previous speaker's words are being translated.
   d) While all participants are “Off the Conference Bridge”, the resulting translation texts, one translation text in the respective language of each participant, is then read by the system separately to each participant in their chosen respective language of choice using Voice Synthesis technology.
   e) After all participants have heard the respective translation of the previous speaker's words, all participants are then brought back “On the Conference Bridge”.
   f) Control is then returned to the “Command and Control” module to continue managing the “Auto-Translate Telephone Call” conversation.

The question of “Who talks next” is essential to “Auto-Translate Telephone Call” conversation management, and a predefined “Call Management Scenario” can be specified by the subscriber through the “Internet Subscriber Interface Module. Possible Call Management Scenarios may include, but are not limited to the following:

Scenario One: “Requesting to Talk”

In this scenario, to get a turn to talk you must say your name. In the case that multiple participants want to talk at the same time, several people say their name. You are allowed to say your name multiple times, and the last participant to say their name, followed by a pause of few seconds (e.g., five seconds) is then given the turn to speak. Of course, this scenario has the inherent assumption that at some point, other participants who want to speak will eventually give in, and stop saying their name. This can be solved by the subscriber who initiated the “Auto-Translate Telephone Call”. The initiator of the call can decide who will talk next by simply saying the name of the participant that the subscriber who initiated the “Auto-Translate Telephone Call” wants to give the right to talk next. The system will automatically grant the right to talk to the participant whose name was specified by the initiating subscriber.

Scenario Two: “Talking in Turn”

In this scenario, each participant is only allowed to talk in turn. The system will call out the name of the next participant allowed to talk by name. The participant, can then either begin talking, or give a voice command to “Pass”, spoken in the participant's respective language. The above-described process can also be implemented through the use of Digital Signal Processing (DSP) by having participants depress (hit) a telephone keypad button, which has been predefined for specific functionality.

2.1. Create and Store Conversation Transcripts:

Since both the Voice Recognition software as well as the Machine Translation software both generate text in electronic format, it is a relatively straight forward matter to create electronic text transcripts of all “Auto-Translate Telephone Calls”, both in each participant speaker's language of choice as well as the respective translations thereof.

The transcripts of every call made by a subscriber are then stored in the subscriber's call history database, which is connected to and accessible from the subscriber's own Internet web portal (i.e., Internet User Interface Module). As a result, transcripts of all “Auto-Translate Telephone Calls” that the subscriber has made are made available for viewing through the subscribers own their own Internet subscriber account web portal.

The text that is generated by the voice recognition for the original language speech of each participant (i.e., prior to translation), as well as the text of the translations of said original language speech prepared for each respective “auto-translate conversation” participant in their respective different languages, will be saved in the subscriber's call history database. As a result, the subscriber can view a complete record of each call, including original speech, and respective translations.

2.2. Statistics & Billing:

For each “Auto-Translate Telephone Call” conversation, statistics will be automatically calculated from said conversation transcripts detailing the “Translation Work Performed” for each of the subscriber's conversations.

These statistics will be generated from the text transcripts of each Auto-Translate Telephone Call made by each subscriber, and will be stored with the subscribers account activity information. Statistics saved and stored will include standard billing information, such as time, date, duration, number of participants, as well as Translation Work performed by the system, such as the number of translated words for each participant. In addition to normal CDR (Call Data Record) information, translation work performed statistical information will be included in said CDR may also be used for billing purposes and can be incorporated in an automatically generated Auto-Translate call CDR for each call. Furthermore, these statistics will be made available for viewing through each subscribers own Internet subscriber account web portal by means of the “Internet Subscriber Interface Module” (see above).

2.3. Calling Modes

Finally, the system will have the capability to be configured using a variety of “Calling Modes”. Calling Modes dramatically increase the flexibility of use of the system, specifically when, how and where the benefits of the system can be derived. The different Calling Modes and the respective uses each of said Calling Modes are described as follows.

The “Conference Call Mode”

In this mode, telephone calls are scheduled and initiated through the Internet Subscriber Interface Module. The Internet Subscriber Interface Module is accessed through the Internet, and therefore can be accessed by the subscriber through the use of any stationary or mobile Internet enabled device, including, but not limited to, a PC computer, Laptop computer or Internet enabled Mobile Phone. The functionality of this “Conference Call Mode” is detailed hereinabove.

The “Non-Scheduled Subscriber Initiated Mode”

This mode enables the subscriber to initiate an “Auto-Translate Telephone call” from “any telephone”, including landline, mobile, as well as a VOIP service to dial a specified telephone bridge number.

This mode is intended for Ad-Hoc Auto-Translate calls in cases where an Internet Enabled device is not available. Using “any-telephone”, the subscriber will call a telephone number. It is recommended that a toll free number be available to use for this calling mode.

The subscriber will be requested to enter an identifying PIN number. The subscriber will be requested to state clearly the name of the specific party, or the specific conference call name, consisting of multiple parties, as defined in the subscriber's “address book” within the subscriber's “Internet Subscriber Interface Module. As a result, the system will know the name(s) and telephone number(s) of the party or parties to be called. The subscriber will then be requested by the system to state subject of the call (i.e., what the subscriber wants to talk about), which will be recorded. At this point the call will be initiated.

For example, the system will automatically telephone Mr. Wong in China and when Mr. Wong picks up the receiver he will be informed in Chinese that he is receiving an Auto-Translate telephone call from “the name of the subscriber” and then Mr. Wong will hear a verbalized Chinese translation of “what the subscriber wants to talk about”. Mr. Wong will then be informed in Chinese that the call is at the expense of the subscriber, and asked if he wishes to accept the Call. In the case that Mr. Wong responds “Yes”, he will be brought “On the Bridge”, and the conversation will proceed and be managed as described above.

The “Receiving Party Initiated Mode” is somewhat different, and is intended for use by third parties, such as Police, Fire or Medical emergency services, or a commercial entity's Customer Service department, who may receive telephone calls in languages that they do not understand. Using this mode there is no conference call bridge telephone number to call, but instead, a telephony server at the receiving party's location is employed. The party receiving the telephone call will select a language, and the system installed in the telephony server will be attached to a “conference-bridge” (e.g., a telephony card) located within the receiving party's telephony server will prompt the caller in the above mentioned selected language, step by step, as to how to use the system.

US Patent Document Reference Cited:

1. USPTO Patent Application 20080177528 (Serial No. 008082, Series Code: 12), Filed: Jan. 8, 2008 “Method of enabling any-directional translation of selected languages”

Other References Cited:
1. Article entitled “Made in IBM Labs: Speech Translation Technology Breaks through Language Barrier for U.S. Forces in Iraq”, Date: Oct. 12, 2006, Source: Market Wire.
2. Article entitled “SRI International Delivers Speech-To-Speech Translators to U.S. Military in Iraq”, Date: Jul. 12, 2006, Source: InDEFENSE.
3. Article entitled “Language Weaver Announces Strategic Investment and Contract from In-Q-Tel; First Commercial Products Using Statistical Machine Translation Methodology Released.

What is claimed is:

1. A system to facilitate Voice Auto-Translation of Multi-Lingual Telephone Calls (also referred to hereunder as “Conference Bridge Call” as well as “Conversation”), utilizing existing voice-to-voice translation technology including VR, SMT and VS, known to those skilled in the art, Telephony DSP (Digital Signal Processing) technology, known to those skilled in the art, as well as Conference Bridge technology of any kind, including but not limited to telephony network server and VOIP, known to those skilled in the art, in which each participant speaks only one language for the duration of a conversation, and there is no limit on the number of participants who may participate in said conversation, provided said number of participants is two or greater, nor is there any limit on the number of different languages that may be employed by said different participants during said conversation, the system comprising:
A User-Interface module component whereby the user defines parameters and preferences to the system, and interfaces with the system regarding the desired use by the user of the various functionalities provided by said system; and
A Command and Control module component that utilizes Conference Bridge Technology of any kind, including but not limited to telephony network server and VOIP, known to those skilled in the art, Telephony DSP (Digital Signal Processing) technology, known to those skilled in the art, and Voice-to-Voice translation, known to those skilled in the art, in order to implement the methodologies and functionalities, detailed hereunder, required to facilitate said Voice Auto-Translation Multi-Lingual telephone conversation.

2. A method, according to claim 1, in which the said User-Interface Module component provides an “Address Book”, similar in content and functionality to a standard email facility address book. Wherein said Address Book is employed by each system user to define individual potential telephone call participants, and for each said potential participant, said address book definition will include the following additional address book information, which are defined as “Required Fields”:
a. Name and/or nickname of the participant
b. Participant's complete telephone number
c. Participant's language of choice

3. A method, according to claim 1, in which said User-Interface Module component's said “Address Book” facility will enable the system user to pre-define multi-participant conference bridge call(s). Each said pre-defined multi-participant conference call containing the names or nicknames of specific individual Address Book participants chosen by said system user, and in which each said pre-defined multi-participant conference bridge call will be given a unique name.

4. A method, according to claim 1, in which said User-Interface Module component will enable said system user to schedule telephone calls by a computer process in which said system user will select telephone call participants from said address book, either individual participant(s) and/or predefined multi-participant conference calls, by selecting the names or nicknames of said pre-defined individuals and/or said pre-defined multi-participant conference call, as well as to enable said system user to schedule the precise date and time at which the system will automatically initiate said telephony conference bridge call.

5. A method, according to claim 4, by which said system user may utilize “any telephony enabled device” to schedule said pre-defined individual participant(s) and/or multi-participant conference bridge calls by telephoning a pre-defined conference bridge telephone number, known to the system. Said user will identify himself/herself to the system through the use of a unique system account PIN number, and once said user is successfully identified, said user may specify the participant(s), either individual participant(s) and/or pre-defined multi-participant conference calls, wherein said specified conference bridge call, as well as to specify the date and time for which the specified conference bridge call will be scheduled. The above detailed functionality will be communicated by said user to said system either by the user through the use of voice commands, where voice commands are understood by voice recognition technology and/or through the use of Digital Signal Processing (DSP), where DSP will recognize the depression of telephone device keypad buttons by said system user.

6. A method, according to claim 1, in which said User-Interface Module component will be provided access to a file containing conference bridge call transcripts of all conference bridge calls made by said system user, whereby said transcript(s) will be generated as part of the processing of the Command and Control module of each conference bridge call made by said system user, and stored by said Command and Control module in a file for subsequent retrieval.

7. A method, according to claim 6, in which said User-Interface Module component will enable said system user to view said transcripts of the conference bridge calls made by said system user. Said transcripts of each said conference bridge call will contain on a sentence-by-sentence basis, both each conference bridge call participant's dialogue as spoken in his/her own language of choice, as well as the translation(s) of said sentence(s) of each conference bridge call participant into each of the other conference bridge call's participant(s) respective language(s) of choice. As a result, said User-Interface Module component will enable said system user to select and view the entire transcript in said system user's language of choice. Alternatively, said User-Interface Module component will enable said system user to view each respective conference bridge call participant's original dialogue in said participant's language of choice, as well as respective translations of said participant's dialogue into the respective languages of choice of all other participants in the selected conference bridge call transcript, on a sentence-by-sentence basis.

8. A method, according to claim 6, in which said User-Interface Module component will automatically calculate statistics from transcripts of each of said system user's conference bridge calls, wherein said statistics generated will detail the “Translation Work Performed” for each of said system user's conference bridge calls. Said statistics for each of said system user's conference bridge calls will be made available to said user for viewing through said user's own “Internet Subscriber's Interface Module”.

9. A method, according to claim 6, in which said User-Interface Module component will utilize said statistics for each of said system user's conference bridge calls to generate a CDR (Call Data Record). The CDR is utilized for the purpose of billing (invoicing) of said system user for system usage charges such as “Translation Work Performed”, “connect time”, and number of participants, etc. for each of said conference bridge call(s) initiated by said system user. For the purpose of clarification, a single CDR record is generated for each conference bridge call initiated by said system user.

10. A method, according to claim 1, in which all functionality of said User-Interface Module component will be accessible and available for use by said system user from any stationary or mobile Internet enabled device, including but not limited to a PC, Laptop or Internet enabled mobile telephone.

11. A method, according to claim 1, in which said Command and Control module component, manages the flexibility requirements of the Voice Auto-Translation of Multi-Lingual Telephone Call in which each participant speaks only one language for the duration of the conversation, and there is no limit on the number of said participants, provided said number of participants is two or greater, and there is no limit on the number of different languages that may be employed by said participants during said conversation, while at the same time making the conversation comprehensible to each participant in that each said respective participant will hear voice translations and all system notifications only in said each participants respective language of choice, said method comprising:
The use of Telephone Keypad Digital Signal Processing (DSP) or Voice Commands to enable said conversation participants to convey specific pre-defined functionality requests and other pre-defined information to said Command and Control module component; and
The use of Voice-to-Voice translation comprising the steps of Voice Recognition to Text of current conversation participant speaker dialogue, followed by Text-to-Text Machine Translation from said current conversation speaker's language of choice to each of said other conversation participant(s) said language(s) of choice, followed by Voice Synthesis of said translation(s) text in each of said other conversation participant(s) respective language(s) of choice; and
The use of Conference Bridge technology of any kind, including but not limited to, telephony network server and VOIP, to facilitate functionality whereby when any conversation participant is currently speaking, all other conversation participants are brought “On-the-Bridge” so that all other conversation participants will hear the current conversation participant speakers original dialogue in his/her own language of choice, and when said current conversation participant speaker wishes that his/her said dialogue be translated and heard by all other conversation participant(s), said current conversation participant speaker will issue a pre-defined telephone keypad DSP signal, such as depressing the pound (#) key on his/her telephone keypad or alternately by vocalizing a pre-defined voice command, which will signal to the Command and Control module component to take all conversation participants “Off-the-Bridge” in order to effect a situation in which each said conversation participant will hear the Voice Synthesis of the translation said current speaker's dialogue in each said conversation participants respective language of choice, without hearing the Voice Synthesis vocalized translation(s) meant for other conversation participants with different respective language(s) of choice, and when all said conversation participants have completed hearing said vocalized translation(s), each in their own respective language of choice, all conversation participants will then be brought back “On-the-Bridge” in order to hear either the continuation of the current speaker's original dialogue in said current speaker's respective language of choice or the next speaker's original dialogue in said next speaker's respective language of choice; and
The use of the methodology disclosed in US Patent Application entitled “Method of Enabling Any-Directional Translation of Selected Languages”, patent application Ser. No. 12/008,082, filed Jan. 8, 2008, in order to enable multi-lingual conversations, with every-directional translation for said interactive multi-lingual conversations.

12. A method, according to claim 11, in which the text of all original speaker dialogue generated by the Voice Recognition to text process (for each system user initiated conversation), as well as the text of all machine translations thereof as generated by said Text-to-Text machine translation of said original speaker dialogue into said language(s) of choice of each of the other respective conversation participants, are saved in a file of conversation transcripts of all Voice Auto-Translation of Multi-Lingual Telephone Calls initiated by said system user, and said conversation transcript file is made accessible to said system user's Command and Control module component.

13. A method, according to claim 1, in which the order in which said conversation participants will talk is determined by said system user who chooses one of multiple pre-defined “Who talks next” scenarios, examples of said possible “Who talks next” scenarios may include, but are not limited to, a round table scenario in which each user talks in turn, or a scenario in which one or more conversation participants request to talk and said system user who initiated the conversation will decide which of said requesting participants will talk next, or a scenario in which said system user who initiated said conversation, will exclusively and on an ongoing basis decide and specify the conversation participant who will talk next. Said system user who initiates said conversation will specify which “Who talks next” scenario will take effect for each said conversation initiated by said system user by selecting said scenario in said user's User-Interface module component for each said conversation, and the implementation and management of said chosen scenario during said conversation, will be performed by the Command and Control module component module during said Command and Control module component's processing of said conversation.

14. A method, according to claim 1, in which the system, specifically the Command and Control module component, can be configured in a “Receiving Party Initiated Mode” which is intended for use by third parties, such as Police, Fire or Medical emergency services, or a commercial entity's Customer Service department, who may receive telephone calls in languages that they do not understand. Using this mode there is no conference call bridge telephone number to call, but instead, a telephony server at the receiving party's location is employed. The party receiving the telephone call will select a language, and the system installed in the telephony server will be attached to a “conference-bridge” (e.g., a telephony card) located within the receiving party's telephony server which will prompt the caller in the above mentioned selected language, step by step, as to how to use the system.
